(19) United States
(12) Patent Application Publication
(10) Pub. No.: US 2008/0193763 A1
(43) Pub. Date: Aug. 14, 2008

(54) Carbonaceous Materials

(76) Inventors: Andrew T. Hunt, Atlanta, GA (US); Miodrag Oljaca, Avondale Estates, GA (US)

Correspondence Address: nGimatCo.;MICROCOATING TECHNOLOGIES, INC., 5315 PEACHTREE INDUSTRIAL BLVD, ATLANTA, GA, 30341-2107, US

(21) Appl. No.: 10/534,569

(22) PCT Filed: Nov. 12, 2003
(86) PCT No.: PCT/US03/36101

§ 371 Date: May 12, 2005

Related U.S. Application Data
(60) Provisional application No. 60/425,236, filed on Nov. 12, 2002.

(51) Int. Cl. B32B 5/16; B29B 9/12; G06Q 99/00

(52) U.S. Cl. 428/403; 264/12; 705/1

(57) ABSTRACT

The present invention is directed to the formation of unique carbonaceous materials and a new segregated manufacturing business of carbonaceous material. In particular, the invention is directed to using a flexible reactor (1) in which spray or vapor can be used to form carbonaceous materials (28) and also in combination with inorganic material (6) to enable performance enhancement of products made using these materials.

### FIELD OF THE INVENTION

The present invention is directed to the formation of unique carbonaceous materials and a new segregated manufacturing business of carbonaceous material. In particular, the invention is directed to using a flexible reactor in which spray or vapor can be used to form carbonaceous materials and also in combination with inorganic material to enable performance enhancement of products made using these materials.

### BACKGROUND OF THE INVENTION

Spray, vapor and gas systems are well known in the art, wherein carbon particles can be made by very fuel rich flame combustion systems or thermal/chemically cracking of hydrocarbon materials. These materials historically have been made from gas-based materials and sprayed materials. In the gas-based systems the hydrocarbon feed stock material is fed in as a gas and then partially burned or thermally cracked. After which, the carbon forms (usually soot) are formed and collected. In the liquid spray systems, droplets of material are formed that are normally hundreds of microns in size. These are then fed into a hot zone. The droplets evaporate as they move through the intense combustion environment forming a fuel gas around each droplet. The hot zone in most cases is a flame and the flame is produced via gaseous hydrocarbons mixed with oxygen containing gases, such as air, which enable high flow. This primary burn enables better oil ignition and cracking of the liquid feedstock. The liquid feedstock in most cases is oil.

### SUMMARY OF THE INVENTION

The current invention is the utilization of ultra-fine droplets even sub-micron size droplets (NanoSpray^{SM} process), which prior to this invention have not been used in the art to form carbonaceous materials. Fuel rich mixtures are formed creating an incomplete combustion environment or are fed into a thermal reactor where cracking of the hydrocarbon occurs. In both cases, an environment exists where freed carbon is produced which readily condensates forming very fine carbonaceous material most often in the form of soot. Various fullerene balls and tubes are examples of other forms that can be made in a wide range of purity. Diamond, diamond-like, carbides, and polymers are additional carbonaceous materials that can be formed with processing variations. An important factor is controlling the amount of available oxygen so that solid carbon containing material is formed such that the available carbon is not completely oxidized into gas or vapor compounds.

The issue with the currently formed carbonaceous materials is that they can range in size and can be highly agglomerated even with some necking of over 90% of the primary particles such that the individual particles are difficult if not impossible to break up thus creating an overall particle size much larger than that desired for many applications. Since the oil is typically contained in large droplets that vaporize and react over a length of the reactor, some reacted material is formed earlier and can grow larger than later reacted material. For many of these agglomerates, the particles vary in size by several orders of magnitude. Even the primary particles making up the agglomerates can vary in size by a few orders of magnitude. It is, therefore, desired to produce more uniform and smaller sized soots and carbonaceous materials for a wide range of applications. For many application it is desired and present invention enables the formation of carbon particles where greater than 20% of the primary particles have no hard agglomeration or necking to other carbon particles, and for some applications it is desired that over 50% of the particles have no necking. To achieve this result in a manner that is low cost for large scale manufacturing processes is also of great desire.

Another issue with the current methods of producing carbonaceous materials is that they are limited in ability to directly combine carbonaceous material with other inorganic and organic materials. This is often desired in order to produce composite, encapsulated, or supported structures for applications in catalysis, electronics and other uses. Current state-of-the-art utilizes pre-made carbonaceous material to combine them with additional inorganic and organic materials. This makes it hard to completely and controllably produce desired composites, encapsulated and supported structures due to the fact that the pre-made carbonaceous material is already agglomerated and passivated which makes most of its surface inaccessible or chemically altered during the formation/reaction of the additional material. Yet another issue with the current methods of producing carbonaceous materials is their inability to produce functionalized and readily dispersible materials and to directly deposit them on suitable substrates to produce desired structures and patterns. Current state-of-the-art relies on post-processing of carbonaceous material to make it suitable for production of ordered arrays and structures for application in field display, sensors and others.

The present invention addresses all of the issues and limitations mentioned above.

A recent innovation, as described in U.S. Pat. Nos. 5,997,956,6,132,653, 6,601,776, 6,390,076, and 6,276,347 have enabled the generation of ultra-fine droplets and formation of various compounds in nanoparticle form using a wide range of liquid feedstocks. This innovative technique is identified as a candidate process for enabling the desired forms of carbonaceous material to be formed and combined with simultaneously formed inorganic and organic materials. One of the key aspects of the current invention for forming the carbonaceous materials is that the combustion system, rather than having a primary gas flame to form the heat and environment for the vaporization and reaction of the oil or other carbon-based source material, uses a method wherein these materials are premixed. This premixing of the oil or other liquid with lower boiling point liquids or gasses can be done either in a single container, through different feed lines and mixed in a smaller mixing chamber or fed into a single line in which it enables enough mixing to obtain the desired uniformity. The mixture or liquid is fed into the atomization system, that will create ultra-fine droplets of more uniform size and distribution along with gas products that can create a burn zone even from a single line feedstock. While this single feedstock is desired, it should be noted that small amounts of gases for pilots could be used to ensure the continued combustion due to the higher velocities, with short residence time, desired to form smaller non-agglomerated particles. The smaller size can be maintained with reduced hard agglomeration by having a rapid quench after the flame sector. The quench can be brought about by the introduction of cooling mediums. Water has one of the highest heat absorption capabilities, is one of the lowest cost liquids, and therefore is one of the most efficient cooling mediums. Any liquid cooling medium, however, can be used including various gases, other liquids (such as liquid nitrogen) to bring about rapid quench of the formed carbonaceous materials, which can be collected by any of the numerous methods that exist in the art. By having a small droplet size to the quench it will be more rapid and more uniform less agglomerated material will result. Having less than 20 microns droplet size quench is desired, and less than 5 micron can be preferred.

Solutions of interest include oils and can be combined with gases such as propane, natural gas, acetylene, butane, etc., or the primary carbon source could be other high carbon containing materials such as xylene or toluene. This combined atomization approach yields great flexibility in selection of liquid solutions and allows controlled production of aerosol with fine droplets and tight droplet size distribution. It is preferred to use an absorbed gas that is a ready producer of carbon such as acetylene and other high carbon producing potential fluids with low boiling points. Non-flammable gasses, such as N₂, Ar and CO₂ can also be dissolved into the liquid carbon source to aid atomization. Additions of oxidizers such as NO₂ or O₂ can result in explosive fluids and should be avoided unless foolproof systems are used. Oxidizers can further reduce droplet evaporation, flame diffusion zones, but can be very dangerous if not mixed and handled properly with the fuels. Ideally these oxidizers are introduced near the atomizing device and the fluids are moving faster than the combustion/flame velocity so that the combustion front cannot propagate to the point of fluid introduction into the reactor. Thus the fuel atomizing benefactor itself can be used to yield some product. The carbonaceous composite can also be formed from all gas sources or a mixtures of liquids, vapors and gasses such materials are known in the art and can readily be found in technical reference books and various chemical catalogs.

Pilots are desired to have a short reaction time, so continuous pilot(s) or a short primary burn zone is used to ensure the combustion of the materials. In close proximity to the point of introduction of the carbon containing feedstock the correct amount of oxidizer whether as air, a gas, or oxygen is introduced to create a primary burn or combustion zone such that the evolution of the freed carbon from hydrocarbon material can be accomplished. By having a well mixed oxygen and carbon precursor spray in such fine atomization, the vaporization time is reduced and thus the reaction zone can be minimized thereby reducing the time of exposure to the reaction to less than 10 milliseconds, even more desirably less than 5 milliseconds, and even more desirably in the 0.1-2 millisecond time range. A tighter primary particle distribution with significantly reduced hard agglomeration can thus be formed. The materials can also be allowed to hard agglomerate, but the resulting material can have unique properties resulting from the hard agglomeration of more uniformly sized primary particles.

In the high heat zone for the cracking and evolution of free carbon from which the soot can form, it is also desired to rapidly quench the material so that the carbon soots primary particles do not form larger hard agglomerates. Therefore, the cooling medium would be fed very proximal to the end of the burn zone. The better the mixing of the cooling medium with the material, the more rapid the cooling can occur. Currently large coolant droplets are sprayed into the hot residual gases and soot, in which local cool zones near the water droplets occur. It is preferred to have a more homogenous dense spray, so the quenching is more uniform. Causing a more uniform and more rapid cool, results in producing more uniform and finer carbonaceous materials. One aspect of the current invention is use of sprats with ultra-fine droplets for quenching of the hot combustion products that contain carbonaceous materials. Having less than 20 microns droplet size quench is desired, and less than 5 micron can be preferred.

The material produced can be just carbon or primarily carbon. The feedstock can also contain precursors of materials that can modify the carbon. These materials can be fed in and dissolved into the primary systems or can be fed into separate nearby flames that would feed in material, thus forming materials on which the carbon can nucleate and grow. Alternatively, precursor materials to coat the carbon after it is formed can be fed in close proximity or downstream of the carbon condensation, thus depositing onto the carbon.

Toluene, xylene, oil-based solution, or even a gas/vapor streams from a wide range of precursors, as disclosed in U.S. Pat. Nos. 5,652,021, 5,858,465,5,863,604, 6,013,318, 6,368,665 used with the previously cited atomization patents, can form reacted material cluster or particles that can function as a primary nucleator for the growth of carbonaceous material, or can be inter-dispersed with or on the carbon-formed material. If it is desired to have a more highly conductive carbon, then materials such as nickel, copper, silver and other conductive metals can be formed with the carbon. It may also be desired to have some elements contained with the carbon such that a top coated material on the carbon will be more stable. Such top coating materials can be catalysts for applications such as refining chemical processing and fuel cells. Materials that may enable the further stability, lower surface energy absorption of catalysts include ceria, lanthanum, nickel and other materials. When platinum or other catalysts are further deposited, from gas streams, onto the virgin, simultaneously formed carbon, they can remain more stable over time yielding net effective higher surface areas over prolonged usages. By forming on virgin surfaces at elevated temperatures, the catalysts or other co-formed materials minimize interfacial energy, which yields increased adhesion and stability.

In many cases, it is desired to have a very uniform mixture of carbon, carbon black and carbonaceous material along with additional materials desired for batteries, catalysts and other applications. Of particular importance are functional materials such as electrochemically and electrically conductive materials or materials that increase the strength or electrical properties when added to a layered structure or dispersed in a medium. To form such composite materials with improved properties, flames can be made wherein in one flame the metal containing complex materials can be made and in other flames, the carbonaceous material can be formed. By co-producing these materials, a more uniform and homogenous mixture prior to agglomeration of either composition of particles occurs significantly by itself. It is desired that the primary clusters or particles be less than 500 nm, more preferably less than 100 nm, and in some cases even predominately less than 40 nm in size when the second composition is bonded or intermixed. Either the primary or secondary other materials added in can be the formed carbonaceous material. An important aspect of the current invention is that separate flames can contain different materials or separate reaction zones of thermal energy can contain the right properties for reaction. Materials can be made wherein the net resulting product flowing in a continuous gas stream is particles of carbonaceous material being intermixed with another predominately non-carbonaceous material, such that metals, oxides, polymers are all formed or combinations thereof are formed with particles that are primarily carbonaceous. It may also be desirable to completely encapsulate carbonaceous material within another inorganic or organic material in order to impart carbonaceous material properties on the bulk parent material without changing its surface properties. For example, carbonaceous and other inorganic particulate materials can be included in a larger polymeric particles by producing the carbonaceous and inorganic materials from a single or multiple flames in a primary reaction zone and by immediately dispersing and mixing of the materials from that first zone with the polymeric or other materials produced from sprays or flames in the secondary reaction zone. Proper design of the mixing chamber and control over the particle temperature and residence time is desired to ensure complete inclusion of the carbonaceous and other inorganic materials into the parent particle material.

By doing this in a single step, one of the great issues is overcome wherein the mixing of materials that are currently formed by separate processes and an agglomeration occurs prior to coating the carbon. These aggregates of small particles as per previous methods can be so tightly bound that they cannot be broken up and the desired fully uniform mixing is extremely difficult if not impossible to achieve. The current invention simplifies this, reduces the number of steps and yields a better more uniform mixture of desired small particles and nanoparticles of composite material. For numerous application the formed composite layer or particle has a thickness or diameter of less than 10 microns, more preferably less than 1 micron, and in some cases less than 100 nm is most desireable.

The sequence in the feeding of the different materials to get uniform mixtures can be important. This is particularly important, if certain materials enable the seeding of certain growth phases of other materials such that the primary material is formed prior to the formation of the second. Such as in the growth of more expensive or desired phases like crystalline materials like platinum that have a similar structure so that the platinum has the right form but less platinum is needed to result in crystalline growth. Alternatively, there are catalyst or seeds for growing certain phases of carbon such as graphite or fullerines (C₆₀ also known as buckminsterfullerene), which can be formed as “buckyballs” or tube type structures. It is thus desired to have the seed or nucleus material form prior to the second material. In the case of fullerine type materials, there are a number of well-known materials that can be used to grow nanotubes and other structures or even a graphite sheet if desired for needed structures. Once again the agglomeration issue is minimized by instead forming the core material in situ. Uniformly and better distributed unagglomerated seed stock is produced. For example, metal catalysts (such as Fe, Ni and/or Co) precursors can be dissolved in a suitable solvent, atomized and dispersed to form submicron droplets. Additional fluids and gases can be metered through separate nozzles to provide the desired aerosol. The metal precursor containing droplets can be processed in a premixed or diffusion flame resulting in formation of catalyst nanoparticles that serve as a nucleus for the nanotube or nanofiber growth. The composition, size and morphology of the catalyst nanoparticles formed in the flame or reactor, can be controlled by controlling process parameters such as the temperature distribution, particle concentration, and residence time in the flame. The present invention is one such method that enables controllable composition generation and flexibility in selection of environmental low-cost solvent and catalyst precursor. A recirculating bed reactor can be used when longer growth times are need to form well structured and purer fullerene materials.

Small primary flames thus could be made which contain the precursors to form the desired starting materials and these primary flames can act as the preburn initiator or even pilot flames for the formation of the carbonaceous materials into which the feed stocks could be sprayed in these primary flames which then act as a pilot to sustain the combustion. Additional sub-pilots may be used for these primary particle-producing flames, which then would be an array of flames centered in an array of sprays of the main carbon precursor materials, which could be sprays or gases of carbon source materials. Alternatively if a combustion process is not used to form the carbon, a wide range of other processes to form the carbon can be made including evaporation of carbon and all other known gas stream processes to form carbon. Heterogeneously formed carbon structures can then be seeded off of the primary particle materials. It is known that such materials as iron, nickel, cobalt, and alloys thereof with a wide range of other materials can be used for seed for the formation of fullerine structures including nanotubes.

The present invention also enables one-step production and deposition of carbonaceous materials, such as nanotubes, nanorods and nanobelts, onto the substrates. In a current state-of-the-art, pre-made nanotubes are treated in a series of steps to enable dispersion, functionalization and deposition of the desired nanostructures onto the final component. The present invention dynamically combines the three-step production, functionalization, and deposition of the carbonaceous material into a one-step process that can naturally functionalize the carbonaceous material during its synthesis and deposit the material under controlled conditions onto the substrates.

In present invention, a portion of the fuel gas is combusted in a diffusion spray flame to produce the elevated temperature while the remainder may serve as the growth reagent. The partial combustion forms intermediate combustion products and species that are involved in partial oxidation of carbonaceous materials, such as carbon nanotubes, and in making of activated carbon. Through control of the flame temperature, stoichiometry and flow configuration, varying degrees of partial oxidation may be introduced into the carbonaceous materials enabling enhanced sensitivity, conductivity and bonding for applications in sensing, electronic, and energy. The present invention offers high potential for one-step fabrication of filters or nanotube coated substrates as may be used for catalyst support, absorption, and energy storage. Predispersed and functionalized carbonaceous material deposited on a support structure could be used as electrode or electrochemical material for refining, reforming, converting, fuel cells, batteries or supercapacitors. Due to their high aspect ratio and conductivity, carbonaceous nanotubes and nanobelts could serve to provide electromagnetic or electrostatic charge dissipation protection. The carbonaceous material dispersed within a composite could serve the dual purpose of reinforcing while further providing electromagnetic or electrostatic charge dissipation protection.

It maybe desired to have certain materials within and/or on the nanotubes or balls in which case additional precursor materials can be fed in with the carbonaceous precursors to form the fullerine. This will result in a filled fullerine tube or ball that contains desired materials. These fullerines or other carbonation form is formed by this seeded stock may be further coated downstream with materials such as catalysts and encapsulation systems that may functionalize the surface. It maybe desired to improve bonding with future matrix material or to keep the carbonaceous materials separated or unagglomerated.

Current carbon powders plants are large volume with significant shipping costs and distances. By using a small flame based system, the amount needed and required in different applications can be made locally. This enables locally varied carbonaceous materials on a Just-in-Time manufacturing basis for a customer or specific customers. The current carbon black manufacturing process creates low cost material at large volumes. Therefore, the carbonaceous material industry sector depends on central manufacture at large facilities from which the product is then distributed. Logistically this is difficult due to the extremely low density of the soots that requires high shipping volumes on a product that is sold at a low price/pound, resulting in high shipping charges per product cost. This is overcome some by pelleting or otherwise increasing the density of the product, but this then creates segregation and dispersion issues of the material at numerous product customers. By making a modular, smaller volume system that is made many times, you enable the low capital structure systems that can be installed on a more regional basis and even at specific customer sites for the formation of the specific desired materials and already dispersed state. Not densifying the finished product saves on the capital cost of each mini-production unit. One significant issue for current carbon plants is the consistency of the feedstock, and having a large facility helps to address this. Using an adjustable atomization devise such as that disclosed in U.S. Pat. No. 5,997,956, can address variation in feed stock material. Variations can be compensated for by the degree of atomization, and alternate hydrocarbon source materials can be used in the same reactor to make product. The distributed production product can be just plain carbon soot's, carbon blacks with enhanced size and shape, un-agglomerated carbons, or even the compound carbonaceous forms enabled by the present invention. This carbonaceous production unit would be located preferably within 10 kilometers, more preferably within 1 kilometers, and even more preferably within 200 m of the manufacturing line that uses the formed material. Being a part of the customer's production line can be most beneficial. Customer is used in its broadest since of relations between different entities and functional groups. The carbonaceous product consumer can regulate the production to just what is needed for its manufacturing line, thus also having preferred logistics. Therefore, this business model invention creates new economic advantages over the current system of the carbon industry.

By use of the present invention pure carbon forms, seeded carbon forms, doped carbon forms, carbonaceous materials containing a wide range of matters can be formed and the materials can be zoned from seed to interdispersed to exterior coated completely or in-part with various materials. Forming a broad range of carbons, carbonaceous materials with a wide range of potential applications from fillers, inks, dyes, stabilizers, catalysts, supports, and even further feedstocks for additional reactions that yield additional materials. Having large production facilities can make forming specialty forms difficult due to the significant change over required between product types, and the inherent limited flexibility of large plants.

In most cases a composite material is formed, but compounds can also be formed. The formation of carbides can require an extended hot zone so that the cation species may completely react with the carbon forming from hydrocarbon decomposition. For carbides it is preferred that the carbon forming material and the cation precursor are uniformly mixed prior to being reacted so that they are more available for atomic bonding to each other during reaction. The reaction to carbide is more likely to be successful if the cation and carbon do not first form independent stable particles. The kinetics to compound formation is very rapid if vapor clusters are formed that contain all the elements. A liquid solution makes an ideal mixture and a flame forms a highly reactive environment. It can be a further advantage to use a metal-organic precursor that has a high carbon forming potential such as neodecanoate or 2-ethylhexanoate based precursors, which in many cases also happen to have high solubility. While this example is drawn to carbides, a wide range of carbon containing compounds maybe formed and the invention is not limited to just carbides as carbonaceous compounds.

The described invention and examples are not limiting, but are merely instructive on how to utilize the present inventions. A wide range of apparatus and processing conditions as is know by various experts can be used. What the materials are used for is also not to be limiting. The materials formed could also be used for chemical reactors and pyrotechnics as visually emissive elements inside the formed soots would be effective in yielding different colors for fireworks or other desired special individual or industrial effects. The current process can also the making of new combinations of material never before attained with novel properties. Since the current method has extensive flexibility these trial compositions can be formed in a combinatorial or other methodology as deemed most appropriate.

### BRIEF DESCRIPTION OF THE DRAWINGS

FIG. 1 is a schematic of a spray process for production of carbonaceous material and incorporation of other inorganic and organic materials.

FIG. 2 shows the enlarged view of the burner that allows premixing of carbonaceous material with inorganic and organic materials.

FIG. 3 shows transmission electron microscope images of carbonaceous material produced using the present invention.

FIGS. 4a-4c show transmission electron microscope images of inorganic material produced with carbonaceous material using aspects of the present invention.

FIGS. 5a-5c show scanning electron microscope images of a combined carbonaceous, inorganic and organic material produced using the present invention.

### DETAILED DESCRIPTION OF THE PREFERRED EMBODIMENTS

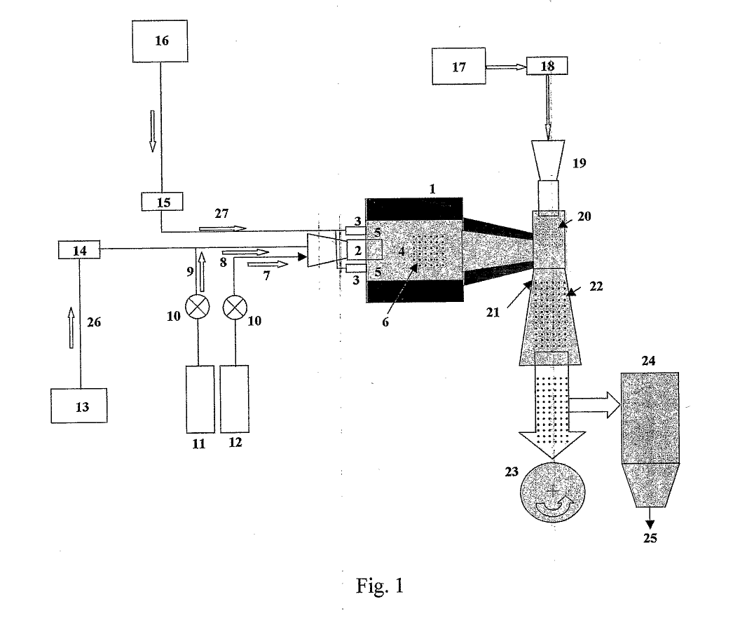

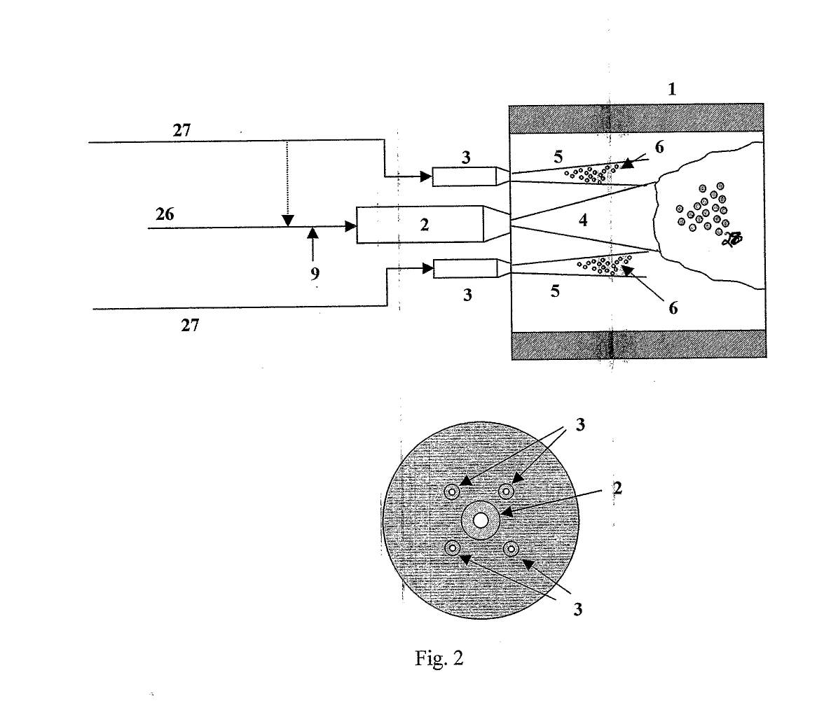

The present invention of reactively creating carbonaceous material in a gas stream or flow may be understood more readily by reference to the following detailed description of preferred embodiments of the invention and the Figures. The advantages of the using the carbonaceous material production process as described by the present invention are best understood by referencing to FIGS. 1-2. In FIGS. 1-2, a reactor chamber 1 is shown having an inlet and outlet. The inlet of the reactor is fitted with the main nozzle 2 through which the carbon precursor solution 26 is pumped into the reactor 1. The flow rate of the carbon precursor solution is controlled by liquid pump 14 that is fed from the solution reservoir 13. Alternatively, the carbon precursors can be mixed with other inorganic and organic precursors in the same solution and pumped through the main nozzle 2. An array of pilot nozzles 3 is arranged around the main nozzle 1 at the inlet of the reactor. Solution with precursors for inorganic and organic materials 27 is fed via pump 15 from the solution reservoir 16 through the pilot nozzles 3 into the reactor 1. The pilot nozzles serve to atomize the solution and form the pilot flames 5 to produce inorganic or organic materials and provide ignition energy for the main spray 4. Additional reaction and liquefied gasses can be added using flow controllers 10. Liquefied gasses or reactants 9 are supplied from reservoir 11 and mixed with the carbon precursor solution 26 to form precursor solution 8. Reaction gasses 7 are supplied from reservoir 12 and mixed with the precursor solution 8, either in the main nozzle 2 or alternatively are sprayed into the reactor 1 via additional ports in the main nozzle 2.

The carbonaceous material 28 and inorganic/organic material 6 formed in the reaction chamber 1 is then fed to a mixing zone 21 in a fluidized bed. An inorganic/organic solution 17 is fed to a spray nozzle 19 via pump 18 to form an aerosol 20, and the carbonaceous and inorganic/organic material 6 is then intermixed, coated or embedded in the inorganic/organic particles in mixing zone 21 to form particles 22. Further coating of the particles or material intermixing can take place via direct deposition on a surface 23 to form a layer of material. The formed layer can be a coating either continuous or discontinuous, and either porous/permeable or not. In the case of collecting particles, these can by example be separated from the gas stream using filters 24 to obtain the desired particles, and are then fed to powder collection apparatus 25.

### EXAMPLE 1

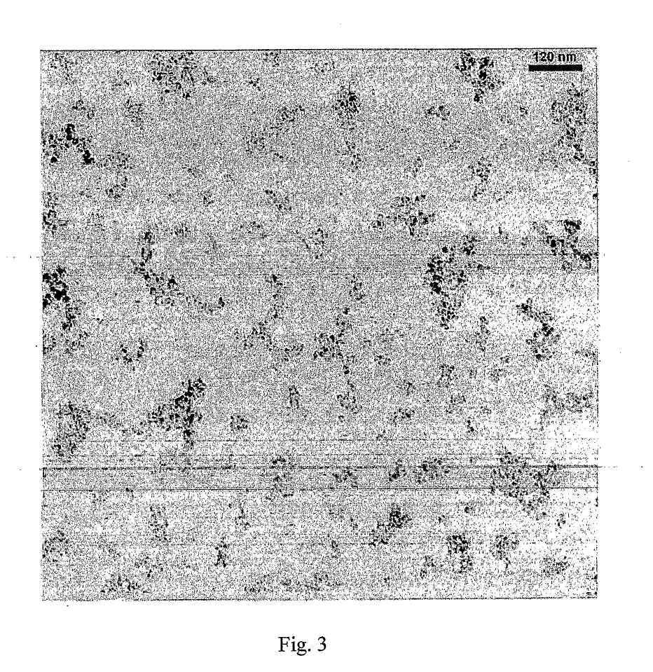

Carbonaceous materials are produced utilizing the carbonaceous process of the present invention. Toluene solvent was pumped through the primary atomization nozzle at flow rate of 3 mL/min resulting in formation of fine aerosol that was ignited using pilot flames of premixed methane and oxygen. A coaxial flow around the spray provided oxygen needed to partially combust fine toluene aerosol. Secondary Nanomiser nozzle provided homogenous dense water/nitrogen aerosol that was used to uniformly and rapidly quench the hot combustion products and carbon black particles produced in the flame hot zone. Application of very fine water spray resulted in a more uniform and more rapid quench and production of more uniform and finer carbonaceous materials. Table below summarizes the operating conditions. Samples or carbonaceous material were collected on glass fiber filters and analyzed using transmission electron microscopy. FIG. 3 shows the TEM image of a typical carbon black material produced in this example.

| | | | Pilot | Pilot | | Quench | N₂ |
|---|---|---|---|---|---|---|---|
| | Primary | Toluene | CH₄ | O₂ | Tip O₂ | water | purge |
| | spray | flow | flow | flow | flow | flow | flow |
| Sample | quality | (ml/min) | (slpm) | (slpm) | (slpm) | (ml/min) | (slpm) |
| S4 | Baseline | 2 | 1.4 | 1.7 | 3.5 | 12 | 40 |
| S5 | Baseline | 2 | 1.4 | 1.7 | 3.0 | 12 | 40 |
| S6 | Baseline | 2 | 1.4 | 1.7 | 4.0 | 12 | 40 |
| S7 | Baseline | 2 | 1.4 | 1.7 | 4.5 | 12 | 40 |
| S8 | Higher | 2 | 1.4 | 1.7 | 4.5 | 12 | 40 |
| S9 | Even | 2 | 1.4 | 1.7 | 4.5 | 12 | 40 |
| | Higher | | | | | | |
| S10 | Lower | 2 | 1.4 | 1.7 | 4.5 | 12 | 40 |

### EXAMPLE 2

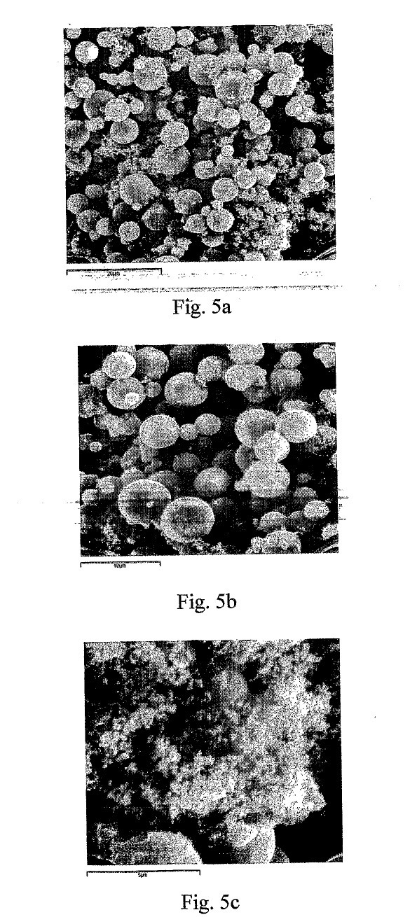

Composite particles of polymer, carbon black and magnetite material were produced using the NanoSpray process, hi this example, feedstock consisting of 70% toluene and 30% propane was pumped at 4 mL/min through the primary Nanomiser burner and partially combusted to produce carbon black and hot combustion products. The resulting plume of hot combustion products and carbon black was mixed with the aerosol produced by atomizing the 9 to 20 mL/min of polystyrene solution in acetone and cyclohexane. Polystyrene feedstock granules were dissolved in a 50/50 by weight mixture of acetone and cyclohexane to form a 2.5 wt % solution of polystyrene. 10 g per liter of magnetite was added to the solution with stearic acid to help suspend the iron oxide particles. The polymer containing aerosol droplets were heated in the chamber by the gases from a carbon-producing flame. This resulted in production of spherical polymer particles containing magnetite and coated with carbonaceous material. FIGS. 5a-5c shows SEM micrographs of spherical and smooth polystyrene particles. Carbon black particles can also be seen around the polymer spheres. Measurement of polymer particle size from SEM micrographs indicates diameters of about 2 to 8 microns.

### EXAMPLE 3

Carbonaceous materials coated with platinum nanoparticles are produced utilizing the process of the present invention. Platinum acetylacetonate precursor was dissolved in toluene solvent at concentration of 100 nM and pumped through the primary nozzle at flow rate of 2 mL/min resulting in formation of fine aerosol that was ignited using pilot flames of premixed methane and oxygen. A coaxial flow around the spray provided oxygen needed to partially combust fine toluene aerosol, evaporate solvent, and react the platinum precursor, which resulted in formation of platinum nanopowders and carbonaceous nanomaterial. Secondary Nanomiser nozzle provided homogenous dense water/nitrogen aerosol that was used to uniformly and rapidly quench the hot combustion products, platinum and carbon black particles produced in the flame hot zone. Table below summarizes the operating conditions. Samples or intermixed platinum and carbonaceous material and carbon black coated with platinum nanopowders were collected on glass fiber filters. If the formed material was exposed to air it was so reactive that it would spontaneously combust, which is not the case of other Pt-carbon material made and used. This demonstrates the change in properties that can be realized by the present invention.

| | | | Pilot | Pilot | | Quench | N₂ |
|---|---|---|---|---|---|---|---|
| | Primary | Pt/Toluene | CH₄ | O₂ | Tip O₂ | water | purge |
| | spray | flow | flow | flow | flow | flow | flow |
| Sample | quality | (ml/min) | (slpm) | (slpm) | (slpm) | (ml/min) | (slpm) |
| S11 | Baseline | 2 | 1.4 | 1.7 | 4.5 | 12 | 40 |
| S12 | Baseline | 2 | 1.4 | 1.7 | 4.5 | 12 | 40 |
| S13 | Baseline | 2 | 1.4 | 1.7 | 3.5 | 12 | 40 |
| S14 | Baseline | 2 | 1.4 | 1.7 | 4.5 | 12 | 40 |

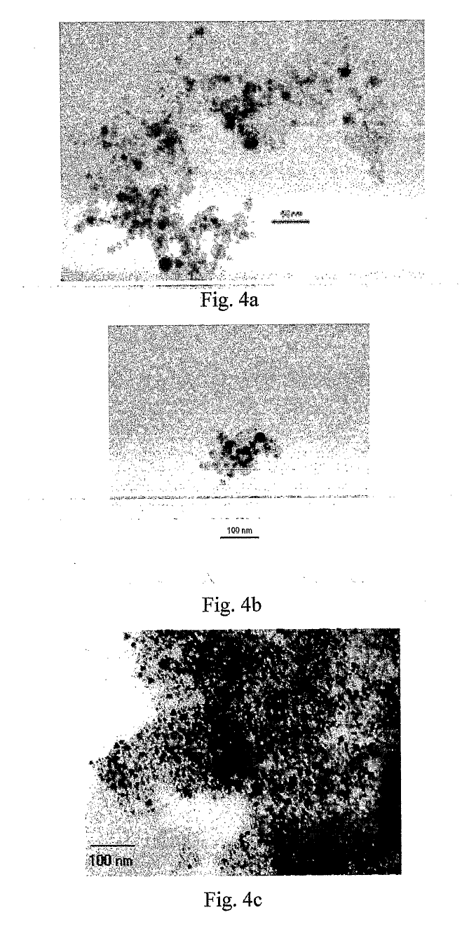

FIGS. 4a-4c show transmission electron microscope images of inorganic material produced using the present invention. The transmission electron micrographs shown in FIGS. 4a-4c demonstrate that nanopowders synthesized using the liquid spray process are loosely agglomerated, with a particle size range smaller than 20 nm, which have carbonaceous material bonded on their surface or inner dispersed with the inorganic material (FeO, Cu and Pt).

What is claimed is:

1. A gas flow chemical process in which organic compound contained in droplets predominantly less than 20 microns in size are reacted in a reaction process to form carbonaceous material.

2. The process of claim 1 in which there is a stream of cooling liquid with sub 20 micron sized droplets injected to quench growth and aggregation of the carbonaceous material.

3. The process of claim 2 wherein the organic compound droplets are predominantly less than 5 microns in diameter.

4. The process of claim 1 wherein the organic compound droplets are predominantly less than 1 micron in diameter.

5. The process of claim 2 wherein the reaction process is a combustion reaction.

6. The process of claim 1 wherein the organic compound contains a cation precursor.

7. The process of claim 6 wherein the material formed is an inorganic with carbonaceous material composite.

8. The process of claim 1 wherein the carbonaceous material formed is a powder with greater than 20% of the formed material being primary particles not having any necking with other primary particles.

9. The process of claim 1 in which a liquid source for the droplets contains liquefied or dissolved gas.

10. The process of claim 1 in which a liquid source of the said droplets is heated sufficiently and released through a nozzle to yield the desired formed size and distribution of carbonaceous material.

11. A gas flow chemical process in which compounds are reacted forming a material comprising a first material that contains cations and a second material that is a carbonaceous material, the first and second materials being formed substantially contemporaneously to form a cation containing carbonaceous composite material.

12. The process of claim 11 in which the composite material formed is a powder.

13. The process of claim 11 in which the composite material formed is a layer.

14. The process of claim 11 in which the material is formed at or above ambient pressure.

15. The process of claim 11 in which the material is formed in vacuum.

16. The process of claim 11 in which at least one additional material is formed in the gas stream and becomes apart of the carbonaceous composite material.

17. The process of claim 11 in which the first material formed is an inorganic material.

18. The process of claim 11 in which the second material formed is a polymer material.

19. The process of claim 11 in which the reaction occurs due to a combustion environment.

20. A composite, said composite comprising inorganic powder predominately less than 100 nm in size, said inorganic material coated at least in part with a carbonaceous material.

21. The composite of claim 20 in which the composite is a powder with a hard agglomerated particle size of less than 1 micron.

22. The composite of claim 20 in which the composite is a powder with a hard agglomerated particle size of less than 100 nm.

23. The composite of claim 20 in which the composite is a layer.

24. The composite of claim 20 in which the composite is a powder with additional material bonded to the surface of the carbonaceous material.

25. The composite of claim 24 in which the thus formed material is electrochemically active.

26. The composite of claim 20 in which the inorganic powder is a metal.

27. The composite of claim 20 in which the formed material adds strength to a medium it is combined with.

28. The composite of claim 20 in which the formed material adds electrical conductivity to a medium when the medium and the composite are combined.

29. A carbonaceous production and distribution methodology comprising: a plant for producing carbonaceous product; and a customer's manufacturing facility for producing a customer's product comprising the carbonaceous product; and wherein the plant is constructed within 10 kilometers of the customer's manufacturing facility.

30. The methodology of claim 29 wherein the said plant is located within 1 kilometer of the customer's manufacturing facility.

31. The methodology of claim 29 wherein the said plant is located within 200 meters of the customer's manufacturing facility.

32. The methodology of claim 29 wherein the said plant is located within the customer's manufacturing facility and the material is fed directly into a production line producing the customer's product, as needed.

33. The methodology of claim 29 wherein the said carbonaceous product is a composite with an inorganic or polymer.
